(19) United States
(12) Patent Application Publication
(10) Pub. No.: US 2010/0161304 A1
(43) Pub. Date: Jun. 24, 2010

(54) METHOD OF INTERCONNECT CHECKING AND VERIFICATION FOR MULTIPLE ELECTROSTATIC DISCHARGE SPECIFICATIONS

(76) Inventor: Steven H. VOLDMAN, South Burlington, VT (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/494,031

(22) Filed: Jun. 29, 2009

Related U.S. Application Data
(60) Provisional application No. 61/181,802, filed on May 28, 2009.
(60) Provisional application No. 61/140,610, filed on Dec. 23, 2008.
(60) Provisional application No. 61/162,232, filed on Mar. 20, 2009.

(51) Int. Cl. G06F 17/50

(52) U.S. Cl. 703/14; 716/5; 716/11

(57) ABSTRACT

A method for designing a semiconductor device circuit comprising a electrostatic discharge (ESD) protection circuit can include device simulations using at least one, for example two or more ESD models, and designing device features such that they are resilient to damage from the two or more ESD testing models.

### CROSS-REFERENCE TO RELATED APPLICATIONS

This application claims priority to provisional U.S. Patent Application Ser. No. 61/181,802 filed May 28, 2009, the disclosure of which is herein incorporated by reference in its entirety.

### FIELD OF THE INVENTION

This invention relates to the field of semiconductor device design, and more particularly to the design of electrostatic discharge circuits and semiconductor chips.

### BACKGROUND OF THE INVENTION

Semiconductor devices are known to be sensitive to damage from electrostatic discharge (ESD), and thus often include ESD protection circuits. During normal operation, a semiconductor device receives a signal on an input pad which is passed to the device circuitry. During an ESD event, the ESD current flows through an alternate current loop: from the input pad, to the ESD device, then to a power rail, and from the power rail to a grounded node, where the current is dissipated without damage to device circuitry.

ESD protection circuits are typically designed to pass one of several different ESD testing models (e.g. ESD test standards), depending on the type and level of protection desired. Present ESD testing models include the human body model (HBM), the machine model (MM), the charged device model (CDM), the transmission line pulse (TLP) model, the very fast transmission line pulse (VF-TLP) model, the human metal model (HMM), and the cable discharge event (CDE), among others.

Semiconductor chips are required to pass these ESD specifications. It is not untypical that a semiconductor chip is expected to pass more than one of these ESD test specifications. Several elements are considered when designing a circuit to pass a particular ESD model.

In general, ESD protection increases with an increasing cross sectional area of a device feature such as a conductive line or interconnect. The material used for the feature also affects the ESD protection, with better protection provided by materials with higher melting temperatures and lower electrical resistance. Proximity to one or more adjacent structures which can function as a heat sink also affects robustness against ESD, as the device feature will not reach its melting temperature as quickly with an available heat sink. Similarly, the heat absorbing properties of a surrounding dielectric material also affects ESD robustness, dielectrics with high heat transfer properties more efficiently absorb heat from a conductive structure during an ESD event, and aid in minimizing the temperature.

The physical dimensions and parameters influence the ESD robustness of the structure, and the ESD level at which failure occurs. The width of a conductive line, such as an interconnect, or transistor gate and the size of contacts to underlying layers in an ESD circuit are typically minimized to provide maximum device density across the surface of a semiconductor chip. However, the ESD circuitry must be sufficiently robust to withstand the specified ESD event. While the dimensions of most device circuitry decreases with subsequent device generations, ESD circuitry must remain of a sufficient size and robustness to prevent damage from an ESD event.

After designing a semiconductor device (e.g., component, chip or system) to pass one ESD model (e.g. ESD specification), the device can be tested to ensure it meets the other required specifications. Typical ESD testing includes placing a charge of a particular voltage and current on a capacitor and discharging it into a semiconductor device over a specific length of time (pulse duration). The voltage, current, and pulse duration depend on the ESD model used for testing. Further, various model values such as voltage levels of 2.0 kilovolt (kV), 4.0 kV, 8.0 kV, etc., can be selected and used with each model, depending on the anticipated intensity of an ESD event during device operation and desired level of protection.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 is a flow chart depicting an embodiment of a method used during design of a semiconductor device circuit;

FIG. 2 is a flow chart depicting another embodiment of a method used during design of a semiconductor device circuit;

FIG. 3 is a schematic depiction of a computer network system which can be used with an embodiment of a method used during design of a semiconductor device circuit; and

FIG. 4 is a chart depicting a tiered approach to ESD verification testing using multiple ESD models.

It should be noted that some details of the FIGS. have been simplified and are drawn to facilitate understanding of the inventive embodiments rather than to maintain strict structural accuracy, detail, and scale.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts.

Present methods of semiconductor device manufacture typically include design and testing to one particular electrostatic discharge (ESD) model at one particular level. Presently, design rules and design verification methodologies only address one ESD specification. Yet, in the qualification of semiconductor chips, it is expected that a plurality of different tests are performed, which the device will be required to “pass”. Additionally, it is anticipated that in the future there will be a need for “tiered reliability” where a design system will be required to adjust the ESD design rules based on the ESD specification value, “tier” or level.

Designing and testing to more than one ESD model would be advantageous to produce a more reliable and robust device (e.g. semiconductor chip). A verification methodology to check resilience to ESD under more than one ESD model could result in a more reliable device customized for more than one ESD model, yet having minimized feature sizes to maximize device density. Such a methodology could avoid metal failure below a specification level, achieve conformance to multiple ESD criteria, avoid functional device failure, and avoid resistance changes and latent metal failures impacting analog networks.

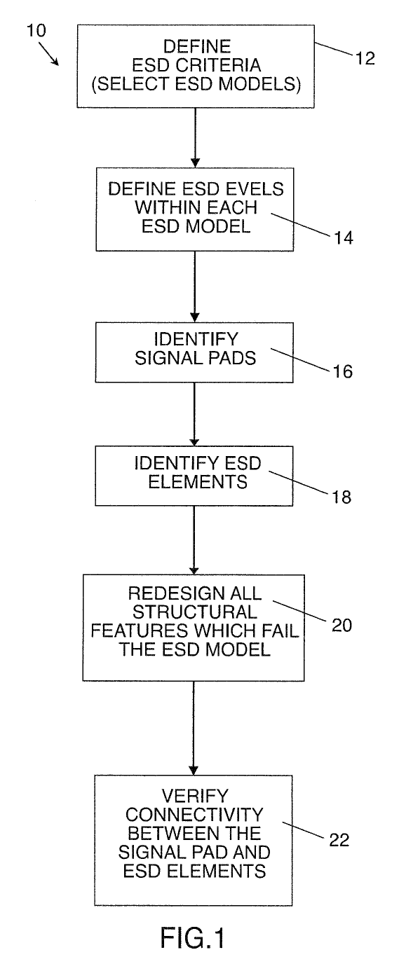

FIG. 1 depicts an exemplary method 10 which incorporates design checking and verification of one or more operating characteristics of a feature, for example a metal line between a signal pad and an ESD network. Various embodiments of the present teachings can be implemented as part of a semiconductor device design software program, such as Cadence® (Cadence Design Systems, Inc., San Jose, Calif.), Knights Camelot™ (Magma® Design Automation, San Jose, Calif.), and Spice (SiSoft, Maynard, Mass.), as well as other design and viewing environments.

In a first step 12, at least one, for example two or more, ESD models are selected for inclusion in the design process. Conditions can include, for example, a specification that the circuit should be resilient to ESD using both the human body model (HBM) and machine model (MM). In this step, a graphical unit interface (GUI) would allow designation of a plurality of different ESD specifications (e.g. ESD models). These can include HBM, MM, CDM, HMM, TLP, VF-TLP, and other models. The models chosen can depend, for example, on customer specifications and/or the eventual use of the device and anticipated types of ESD events associated with the particular use. In this step, the GUI would designate the specific models invoked for qualification of the semiconductor component. The design system would verify that all critical interconnects, wiring and devices sizes are chosen to pass the specifications.

In a second step 14, voltage, current, and pulse conditions for each of the ESD models are selected. In the case of HBM or MM model, only the voltage level is designated. In the case of TLP model, the pulse width, rise time and current magnitude would be designated. For example, it can be specified that the circuit should be resilient to damage with the human body model at a voltage of 4 kV, and with the machine model at 800 V. A design system can designate a technology “tier” in the GUI which combines the ESD specification in groupings as well. For example, a Tier 1 can be designated that gangs specific ranges of different models into groupings, or tiers. In this fashion, the design parameters would be designated to insure passage of all specification in that tier grouping.

In a third step 16, electrical connections which may be susceptible to ESD damage are identified. For example, a metal line leading from an input signal pad to the ESD network may be subject to ESD damage. The metal interconnect width would be defined to be large enough (for a given design level) to pass all the specifications within the grouping or tier. In semiconductor design, the film thickness and the material are defined by the technology. Each metal interconnect level, vias and contacts are defined based on a given semiconductor process. A circuit designer is allowed to vary the interconnect line width, interconnect line length, orientation, and design layer level. The design system would identify the wire interconnect feature, and one or more dimensions for the feature, then check and verify that the specified dimensions are likely to conform to the ESD specifications and ESD values to a certain probability level for that given film thickness and material type. In the case of a developer of a semiconductor process, card or board developer, the developer has the freedom to define the film thickness, and the materials.

In a fourth step 18, elements of the feature which can be designed to check, verify or improve resilience to ESD damage are identified. For example, for a technology developer, cross sectional area of a metal line, the material of the metal line, a liner used to improve electrical conductivity, the insulation material surrounding the metal feature, etc. are identified. For a system where only the physical dimensions are controlled (e.g. design width and length) the cross sectional area of a metal line can be defined, whereas the material of the metal line, a liner used to improve electrical conductivity, the insulation material surrounding the metal feature, etc. are predefined and identified. The design system addresses the design level (or design layer) and material type, since each design level (or design layer) of metallization will have a different ESD robustness. The design system obtains the information of the design level along the path between the ESD input and the ESD network. In this process, the path is followed through the different metal levels, vias and contacts; the design system determines the path, and checks conformance on each design level to satisfy the multiple ESD specifications and magnitudes.

In a fifth step 20, the elements which improve ESD robustness are adjusted until a feature simulation indicates that the feature will pass the combination of ESD models selected in the first and second steps. The design system can also designate “failure” to the specification, a “flag” is defined alerting the designer the wire did not conform to the specification.

In a sixth step 22, connectivity associated with the feature is tested to insure electrical integrity. In the exemplary embodiment, electrical connectivity between a signal pad and the ESD network along the metal line is tested.

Once all device features which are susceptible to ESD damage are tested and pass the specified ESD models and levels, device manufacture can continue using additional conventional design and manufacturing processes.

It is to be understood that additional steps for this and other embodiments of the invention can be envisioned by one of ordinary skill in the art. Further, the order of the steps is exemplary, and sequences of steps other than those specified herein are possible.

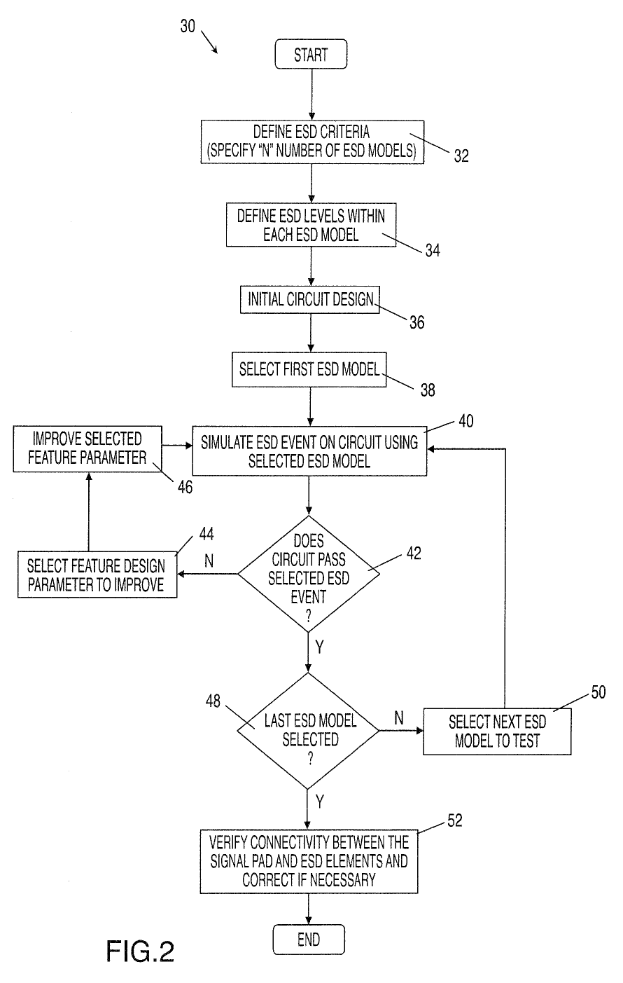

Another exemplary embodiment 30 is depicted in FIG. 2. In this embodiment, the method starts and “N” number of ESD models are specified for testing 32. The “N” number of ESD models can be specified as a particular group or reliability tier, which can include specific models and specific electrical event levels for each model. For example, the human body model (HBM), the machine model (MM), and the charged device model (CDM) may be selected for testing of a semiconductor device, with specific voltage levels and other testing parameters such as pulse duration defined 34 for each model. Once the initial circuit is designed 36, the first ESD model is selected 38, an ESD event using the selected model is simulated on the initial circuit design 40, and pass/fail results are determined 42. If the circuit does not pass the simulated ESD event, the failing feature is determined and a feature design parameter is selected to improve 44. The selected feature parameter is improved 46, and the ESD event is again simulated on the redesigned circuit 40. If the circuit again fails, the previously improved feature design parameter can be further improved, or another design feature related to the failing feature can be selected for improvement. Once the circuit passes the ESD model, if another model remains to be tested 48, the next ESD model is selected 50 and testing using the next ESD model 40 and correction of the circuit, if necessary, continues. Once the simulated circuit passes all ESD model simulations defined at 32, connectivity between the signal pad and the ESD elements is checked and corrected if necessary 52.

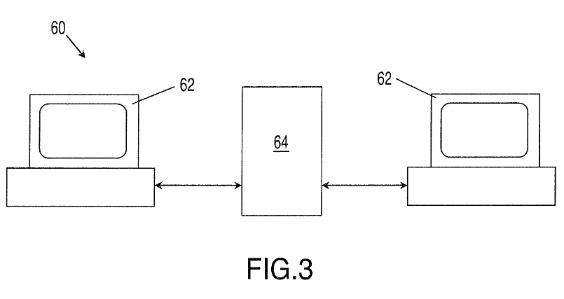

FIG. 3 depicts an exemplary computer network system 60 which can include one or more computer devices 62 which receive user input and display semiconductor device design information. The computer network system can further include a server 64. Either the server 64, the computer device 62, or another device structure not individually depicted can include a computer readable storage device such as read-only memory, random access memory, a hard drive, a CD, a DVD, other optical medium, a floppy drive, etc. The computer readable storage device can have stored information including semiconductor device design software having a module which provides a method of interconnect checking and verification for multiple ESD specifications according to the present teachings. The stored information can cause the computer to perform this process or method of verification of interconnection specification criteria, which can include a plurality of ESD specifications for semiconductor device circuitry.

It should be noted that the various steps can be modified from the order depicted and described, and other additional steps can be performed. Thus this description provides an overview of a method of interconnect checking and verification for multiple ESD specifications.

In another embodiment, various device element parameters can be designed using a lookup table of known values required for passing each ESD model. For example, if it is known that an interconnect line of aluminum requires a cross section of a specific area to withstand an ESD event of a given voltage under a first ESD model, the interconnect line can initially be designed to this minimum specification. In checking conformance to a second ESD model, if the second model has a more damaging effect on the feature and requires a larger minimum cross sectional area (or other design criteria such as a different material, a surrounding dielectric having a better thermal conductivity, etc.) to withstand the ESD event, the feature is specified at this larger cross sectional area (or other design criteria). Each feature subject to ESD damage is checked to each ESD model in turn, with the final design value for each feature being the minimum value required to pass the most damaging ESD model.

As with previous embodiments, the various steps can be modified from the order described, and other additional steps can be performed.

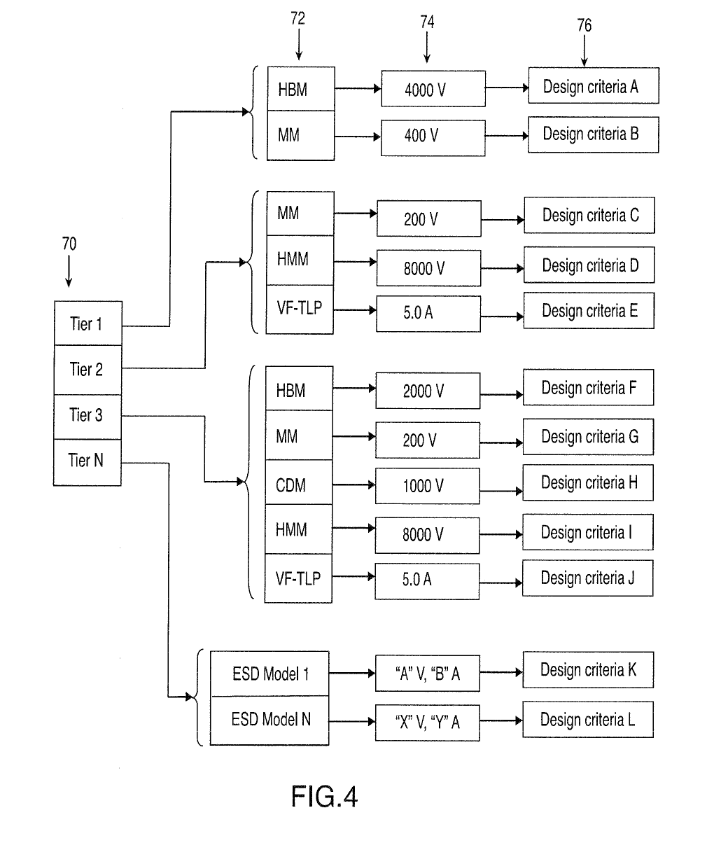

FIG. 4 is a schematic depicting an embodiment of a tiered approach to ESD modeling during device design. This embodiment comprises “N” number of different tiers 70, “Tier 1” through “Tier N,” each of which specifies one or more ESD models 72. A tier requirement for a device or device circuit is specified based on the ESD events the device is expected to be subject to during its use, and the device can be designed to withstand all of the ESD events within the specified tier.

After initial design of the particular device or device circuit, and a specification that the device should pass, for example, the events of Tier 1, the first Tier 1 ESD event (the HBM model at the specified levels) can be simulated on the circuit at the levels specified 74 for that event. If the device or circuit fails, the failing feature is determined and a feature design parameter to improve is selected, for example in accordance with FIG. 2. The selected feature is improved, and the circuit simulation is again performed until the device passes the ESD event. Exemplary elements related to the specific feature design (feature dimensions, etc.) required to pass the ESD event are indicated at column 76. It should be noted that the Tiers 70, ESD models 72 within each tier 70, testing levels 74 for each ESD model 72, and design requirements 76 required to pass each ESD event are arbitrary and for exemplary purposes only.

Subsequently, the next Tier 1 ESD event (the MM model at the specified levels) can be simulated on the circuit. Each event is simulated in turn and failing features are improved until the circuit passes all ESD events. As an example, the first Tier 1 event may require the human body model (HBM) voltage at 4000 V, and a machine model (MM) at 400 V. A second example of a Tier 1 objective may require a HBM level of 2000 V and MM level of 200 V. As a second example, a product may need to be developed that requires passage of a HBM, MM, CDM, HMM and VF-TLP specification. In this case, the product may require a 2000 V HBM, 200 V MM, 1000 V CDM, 8000 V HMM, and 5 A VF-TLP event. In this case, the Tier 3 would be required to pass all of these different events for product qualification.

With regard to FIG. 4, various ESD event conditions can be included at 74, for example one or more of voltages, amperages, pulse duration, etc. The ESD event conditions can be the same for a specific model from tier to tier, or the conditions can be different for a specific model from tier to tier. Further, the design criteria identified at 76 can include one or more parameters which are allowed to be modified at the design stage subsequent to process development, such as line width, interconnect line length, orientation, design layer level, etc. Designing a circuit with the most stringent design criteria identified in 76 for a specific tier can result in a circuit able to pass all specified ESD event modes and levels. Not exceeding the most stringent criteria identified in 76 will minimize space requirements for the ESD circuit.

In the case that the process is defined, the material types are defined in the technology. Whereas the developer can change the materials, the material types can be specified. In most semiconductor development, the film thicknesses, and material properties are pre-defined by the semiconductor fabricator. Additional method steps can be performed, and the order of the method described and depicted can be varied.

In an alternate method, simulation of device features can be performed to determine the specific design criteria which are needed for a specific device feature to pass an ESD model at a specified level. For example, each of the requirements specified in FIG. 4 at column 76 can be determined through either simulation or physical testing of an actual device feature, and included in a lookup table. When a tier is specified during subsequent design of another device, the lookup table can be consulted and used to determine the minimum feature design criteria required to pass all of the ESD events within the specified tier. For example, most robust feature design from column 76 for the specified tier can be used to design the device to ensure that the device is sufficiently resilient to all ESD events within the specified tier, without overdesigning the device which would result in unnecessary cost to the device.

Embodiments of the invention are not meant to be limited to the design of a semiconductor die, except where expressly stated as such. It is contemplated that various embodiments can be applied to the design of other semiconductor components such as system boards, printed circuit board, motherboards, interface boards, etc., as well as semiconductor chips.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A computer readable medium, comprising:
a computer readable storage device causing a computer to perform a process or method of verification of interconnection specification criteria
wherein the specification criteria comprises of a plurality of electrostatic discharge (ESD) specifications for semiconductor device circuitry.

2. The computer readable medium of claim 1, wherein the specification criteria further comprises:
a plurality of tiers;
a plurality of different ESD models within each of the plurality of tiers; and
a plurality of ESD simulation criteria for each of the plurality of different ESD models.

3. The computer readable medium of claim 2, wherein the specification criteria further comprises a lookup table of known values required for passing each ESD model.

4. The computer readable medium of claim 1, wherein the specification criteria further comprises a plurality of different ESD models, wherein each ESD model comprises a set of ESD event specifications.

5. A method for designing a semiconductor device component, comprising:
specifying a set of semiconductor device component design criteria, wherein the set of semiconductor device component design criteria comprises at least one ESD model;
prior to manufacturing the semiconductor device component, simulating an ESD event for the at least one ESD model on the semiconductor device component design; and
verifying through simulation that the semiconductor device component design is resilient to the ESD event for the at least one ESD model.

6. The method of claim 5, wherein:
the set of semiconductor device component design criteria comprises at least two ESD models;
prior to manufacturing the semiconductor device component, simulating an ESD event for each of the at least two ESD models on the semiconductor device component design; and
verifying through simulation that the semiconductor device component design is resilient to the ESD event for the at least two ESD models.

7. A method for designing a semiconductor device circuit, comprising:
designing a semiconductor device circuit comprising an electrostatic discharge (ESD) protection circuit;
simulating a first ESD event using a first ESD model on the semiconductor device circuit;
if the semiconductor device circuit fails during the first simulated ESD event:
determining which semiconductor device circuit feature failed the first ESD event;
selecting a device feature parameter for modification in response to failing the first ESD event;
modifying the device feature parameter selected in response to failing the first ESD event; and
again simulating the first ESD event on the semiconductor device circuit;
after simulating the first ESD event, simulating a second ESD event using a second ESD model different than the first ESD model on the semiconductor device circuit;
if the semiconductor device circuit fails during the second simulated ESD event:
determining which semiconductor device circuit feature failed the second ESD event;
selecting a device feature parameter for modification in response to failing the second ESD event;
modifying the device feature parameter selected in response to failing the second ESD event; and
again simulating the second ESD event on the semiconductor device circuit.
